(19) United States
(12) Patent Application Publication
(10) Pub. No.: US 2006/0109117 A1
(43) Pub. Date: May 25, 2006

(54) Apparatus and Method of Intelligent Multistage System Deactivation

(75) Inventors: Louis C. Hsu, Fishkill, NY (US); Lawrence A. Clevenger, LaGrangeville, NY (US); Carl J. Radens, LaGrangeville, NY (US); Kwong Hon Wong, Wappingers Falls, NY (US); Chih-Chao Yang, Poughkeepsie, NY (US); Timothy J. Dalton, Ridgefield, CT (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/904,664

(22) Filed: Nov. 22, 2004

(51) Int. Cl. G08B 13/14

(52) U.S. Cl. 340/571

(57) ABSTRACT

A deactivation management unit for facilitating an intelligent multistage system deactivation process where the deactivation management unit is flexible, facilitates recovery, and renders reverse engineering nearly impossible after the system has been permanently deactivated.

### BACKGROUND OF THE INVENTION

The present invention relates to an apparatus and method of facilitating hardware deactivation, and particularly, to an apparatus and method of facilitating a multiple-stage hardware deactivation process.

It is desirable to provide circuits and/or systems that are capable of intelligent hardware self-deactivation based on one or more deactivation indicators such as indication of system tampering, security alarm, non-standard operating mode, license expiration, password expiration, or other factors. Hardware deactivation renders the system, or portions of the system, non-functional. Hardware deactivation may be required in response to any number of external and/or internal stimulus such as tamper detection, license revocation, security breach, cryptography, confidential systems and data control, secure transaction processing, autonomous operation, and/or remote control. Software realization of system deactivation, which may be used in some applications, can be subject to tampering, alteration, or modification from a hostile system user or intruder, for example, by code or cryptography hacking.

Most conventional techniques incorporate software-initiated deactivation schemes. Software-initiated deactivation schemes are prone to tampering, hacking, alteration, or modification as compared to hardware-based schemes. Conventional hardware-based deactivation schemes are typically inflexible and prone to reverse engineering. For example, U.S. Pat. No. 6,114,960 (“the '960 patent”), assigned to the assignee hereof and entitled “Method And Apparatus For An Integrated Security Device For Automatic Disablement,” incorporates a microprocessor for detecting and addressing unauthorized access. The '960 patent also describes a warning interval, where the microprocessor provides a warning to a user to enter an authorization code. A time-out interval is also provided to carry out deactivation which includes partial deactivation allowing a service center to obtain authorization. Destructive deactivation is also provided which disables circuits within the device that are necessary for operation.

However, the '960 patent fails to disclose a deactivation management unit that can be embedded into a system design such as a System-On-Chip (SOC) design where the SOC design comprises a CPU (or other controller unit) and other macros. In other words, the '960 patent fails to disclose the concept of having a deactivation management unit that resides outside the CPU and that is capable of handling deactivation situations independently from the CPU. Many conventional techniques teach an automatic disabling procedure where codes are installed into CPU registers during manufacture (e.g. fuse), and a timer counts the amount of time from when an entered codes does not match the stored code. When the timer is activated, logic stored in the registers is triggered and disables the CPU. Such a security method is well known in the mainframe processor art. However, conventional hardware deactivation techniques do not teach deactivation management units separate from the CPU for managing deactivation of the system. Conventional techniques typically incorporate only a few circuits and fuses for deactivating the CPU. Such techniques make the deactivation process inflexible and make recovery difficult.

Additionally, the '960 patent fails to clearly define each shutdown stage. The '960 patent only identifies two shutdown stages. The '960 patent only involves shutting down a processor, and therefore, is not suitable for deactivating an entire system such as a SOC design. Also, the '960 patent does not disclose the concept of dispersing the deactivation management circuits used to deactivate the processor about the chip. By physically dispersing the deactivation management circuits amongst other system circuits and by adding “dummy” features (e.g. inactive circuits), reverse engineering becomes very difficult, thereby improving the security features of the system. For example, conventional chip destruction techniques involve blowing fuses to permanently disable a CPU. However, by reverse engineering, a competitor could easily copy the design even though fuses have been blown. Additionally, conventional hardware deactivation techniques fail to teach how to avoid unintentionally triggering system shut down and how to recover from such unintentional triggering.

In view of the foregoing, there is a need in the art for a hardware-based deactivation management unit for providing multi-stage system deactivation where the deactivation management unit is flexible, facilitates recovery, and renders reverse engineering nearly impossible once the system has been permanently deactivated.

### BRIEF SUMMARY OF THE INVENTION

The present invention addresses the above-described problems by providing a deactivation management unit (DMU) for providing multi-stage system deactivation where the deactivation management unit is flexible, facilitates recovery, and renders reverse engineering nearly impossible after the system has been permanently deactivated. In accordance with one aspect of the invention, the DMU facilitates a method of systematically deactivating the system in response to one or more deactivation indicators. The deactivation indicators can be generated externally or internally to the DMU.

More specifically, the DMU initiates an intelligent multistage deactivation process in response to the deactivation indicator. The DMU initiates a number of deactivation stages, each deactivation stage further deactivating system macros. When the final deactivation stage is executed, the system macros are destroyed, thus rendering the system inoperable. The DMU sends deactivation codes to a plurality of system macros over a communication means. Each system macro processes the deactivation codes to determine what action, if any, each particular macro is to take during a particular deactivation stage.

The first stage of the intelligent multistage deactivation process disengages certain features of particular system macros, the second stage disables certain features of particular system macros, the third stage disrupts the operation of particular system macros, and the fourth stage destroys particular system macros. Once the multistage deactivation process has initiated, but before any system macros are destroyed, the system can be recovered by an appropriate recovery routine facilitated by the DMU.

In another aspect of the invention, the deactivation circuits that comprise the DMU are dispersed throughout the system design instead of placed in a central location to make reverse engineering nearly impossible.

According to a further aspect of the invention, an electronic system having a DMU is deactivated in multiple stages by initiating an intelligent multistage deactivation process, initiating a plurality of deactivation stages, executing the deactivation stages in response to a deactivation code, and deactivating a plurality of macros in accordance with a particular deactivation stage.

Specifically, the macros can be disengaged by erasing data stored in memory macro(s), halting operation of controller macro(s), and/or tri-stating drivers and receivers of I/O interface macro(s). In the absence of a recovery code, the macros can then be disabled by powering down the memory macro(s), erasing programs and data stored in the controller macro(s), and/or powering down the I/O interface macro(s). Still in the absence of a recovery code, the macros can then be disrupted by disabling a power-on sequence of a DRAM memory macro(s), disabling a timing circuit of a SRAM macro(s), disabling a voltage generator circuit of a flash memory macro(s), disabling decoupling capacitance of the controller macro(s), disabling a power-on sequence of the controller unit(s), skewing a clock signal of the controller unit(s), skewing a differential circuit load of the I/O interface macro(s), altering bias currents of the I/O interface macro(s), subjecting current or voltage reference generators of the I/O interface macro(s) to noise, distorting a clock cycle of the I/O interface macro(s), and/or tuning an impedance matching network of the I/O interface macro(s) to induce attenuation and reflection. Finally, still in the absence of a recovery code, the macros are finally destroyed by shorting a power supply to ground, altering a power-on sequence of the DRAM memory macro(s), and/or altering a power-on sequence of the controller macro(s).

Further and still other aspects of the present invention will become more readily apparent when the following detailed description is taken in conjunction with the accompanying drawing figures.

### BRIEF DESCRIPTION OF THE DRAWINGS

The objects, features and advantages of the present invention will become apparent to one skilled in the art, in view of the following detailed description taken in combination with the attached drawings, in which:

FIG. 1 illustrates an electronic system according to an embodiment of the present invention;

FIG. 2 illustrates an intelligent multistage system deactivation method according to an embodiment of the present invention;

FIG. 3 illustrates a deactivation management unit (DMU) according to an embodiment of the present invention;

FIG. 4 illustrates deactivation codes according to an embodiment of the present invention;

FIG. 5 illustrates a DMU state machine according to an embodiment of the present invention;

FIG. 6 illustrates an exemplary eDRAM power-on sequence; and

FIG. 7 illustrates an on-chip clock generator according to an embodiment of the present invention.

### DETAILED DESCRIPTION OF PREFFERED EMBODIMENTS OF THE INVENTION

The present invention teaches a deactivation management unit for providing multi-stage system deactivation where the deactivation management unit is flexible, facilitates recovery, and renders reverse engineering nearly impossible after the system has been permanently deactivated. The Deactivation Management Unit (DMU) of the present invention initiates an intelligent multistage system deactivation process in response to one or more external and/or internal deactivation indicators such as, for example, indication of system tampering, security alarm, non-standard operating mode, license expiration, password or ID expiration, or any other suitable indicators. When a deactivation indication occurs, the DMU facilitates a method of systematically deactivating (e.g. shutting down) the system in response to the deactivation indicator as described infra. Any signal capable of indicating that the system is to be deactivated is within the scope of this invention, and as such, the specific deactivation indicators described herein are for illustrative purposes only.

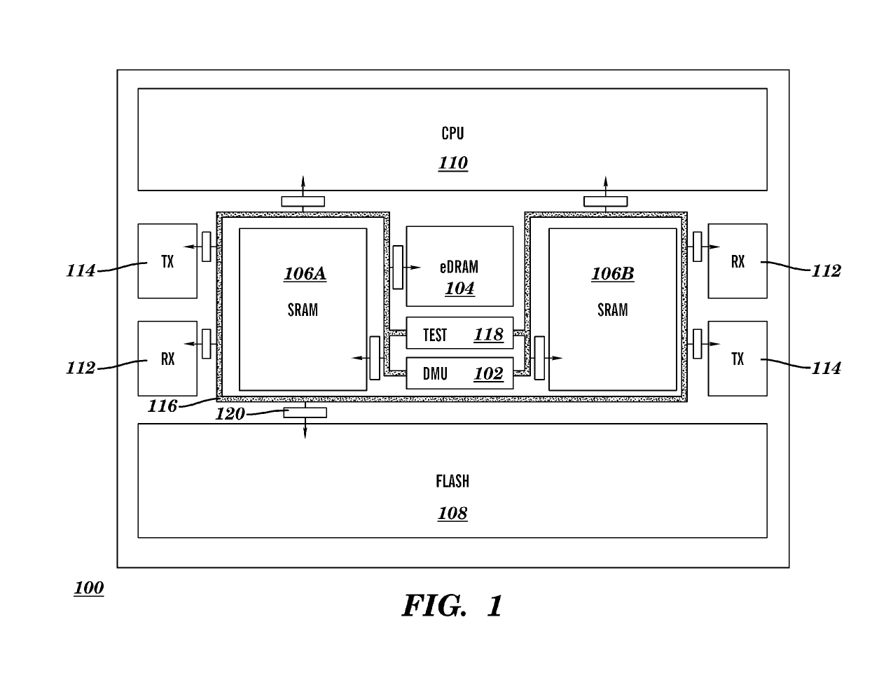

FIG. 1 illustrates an exemplary System-On-Chip (SOC) system 100 that includes DMU 102. In addition to DMU 102, SOC system 100 can include any other suitable macros such as: at least one memory macro, such as a volatile memory, for example embedded DRAM (eDRAM) 104 or SRAMs 106A and 106B, or both, or nonvolatile memory, for example, flash memory 108, or both; a controller macro such as CPU 110 or any other suitable controller unit; at least one I/O interface macro, such as a duplex analog I/O interface having a receiver 112 and a transmitter 114; a communication means, for example, scan chain 116; and control logic and testing macro 118 for control and test functions.

In response to one or more deactivation indicators, DMU 102 facilitates an intelligent multistage deactivation (e.g. shutdown) of SOC system 100. The system deactivation process comprises multiple stages of deactivation, where the stages range from temporarily deactivating portions of SOC 100 to non-recoverable, final-destruction of SOC 100. DMU 102 can comprise a state machine for executing orders that correspond to the particular system design, the deactivation indicator received, and the stage of deactivation. System deactivation can range from permanent deactivation of the entire system to temporary disablement of certain features of particular hardware macros.

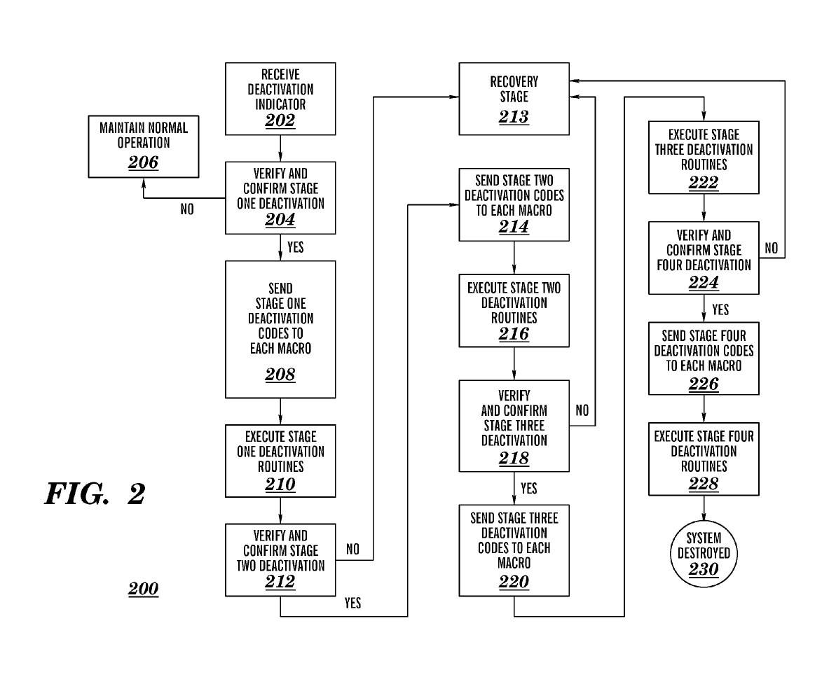

FIG. 2 illustrates an exemplary embodiment of the intelligent multistage system deactivation method of the present invention as facilitated by DMU 102 of FIG. 1. The intelligent multistage deactivation process preferably comprises four stages; however, any number of suitable deactivation stages can be implemented. Before entering each stage, the DMU verifies and confirms whether a particular deactivation stage should initiate. The first stage disengages certain features of particular system macros. The second stage disables certain features of particular system macros. The third stage disrupts the operation of particular system macros. The fourth stage destroys particular system macros. Once the intelligent multistage deactivation process has initiated, but before any system macros are destroyed, the system can be recovered by an appropriate recovery routine. The recovery routine can be facilitated by the DMU and depends on the deactivation stage and the particular macro(s) that have been deactivated. Once the fourth stage has initiated, the system can no longer be recovered from the deactivation process because one or more macros have been, or are being, permanently destroyed, thus rendering the system permanently inoperable.

The DMU initiates a particular deactivation stage by sending deactivation codes from the DMU to each macro. The deactivation codes can be sent from the DMU to the system macros via any suitable communication means, such as, for example, a scan chain. As illustrated in FIG. 1, scan chain 116 can be the original scan chain designed for macro testing and debugging. Alternatively, scan chain 116 can be added to the system solely for facilitating system deactivation in accordance with the present invention. The deactivation codes are loaded from scan chain 116 into local shift registers. As illustrated in FIG. 1, local shift register 120 stores deactivation codes received from scan chain 116 for flash memory macro 108. Each system macro receives the deactivation codes from the DMU and subsequently processes the codes to determine what, if any, deactivation procedure the particular macro is to execute.

Upon receiving one or more deactivation indicators 202, the DMU verifies and confirms whether the first deactivation stage is to be initiated 204. If the DMU is not able to verify and confirm that the first deactivation stage should initiate, the system remains in normal operation 206. For example, if the DMU is not able to confirm deactivation or if the deactivation indicator(s) indicate a false alarm, the system continues normal operation. For illustrative purposes only, the DMU could check a password or identification code to verify the deactivation process. Alternatively, the DMU could seek assistance from a remote service center via a network connection. After a predetermined period of time, if the DMU does confirm the deactivation process, deactivation codes corresponding to the first deactivation stage are sent 208 from the DMU to the respective system macros via the communication means. The deactivation codes are then loaded into the local shift registers.

Each system macro connected to the communication means then processes the deactivation codes 210 to determine what, if any, action each particular macro is to take. Preferably, after sending the deactivation codes to the macros, all macros except the I/O macro disengage from normal operation. How each particular macro disengages from operation depends on the functionality of the particular macro. For example, disengagement can be a simple power down switch that removes power to each macro. Alternatively, or in addition to the power down procedure, the operation of each macro could be halted, or locked, so that they are not capable of functioning normally (e.g. idle operation of a CPU). Also, for memory macros, memory array contents could be erased to prevent data tampering. The main objective of the first deactivation stage is to stop normal operation of the system macros so that system operation cannot be observed by an intruder.

After the first deactivation stage has completed, the DMU determines whether to enter the second deactivation stage 212. While waiting to initiate the second deactivation stage, the DMU could transmit a signal through the system I/O interface over a network to a remote service center to seek disposition advice. If the DMU receives a response and the response indicates that the deactivation process should be terminated or cancelled, the DMU can enter system recovery stage 213 whereby each macro is returned to its normal operating state. Alternatively, if the deactivation indicator suggests that the deactivation stimulus which triggered the indicator has subsided, the DMU can enter system recovery stage 213. For example, the DMU can initiate a system recovery by downloading recovery codes from the remote service center and performing recovery operations that correspond to the downloaded recovery codes. Alternatively, the DMU can initiate a system recovery by accessing recovery codes stored within the DMU and performing recovery operations. However, if within a predetermined period of time, the deactivation process is not to be terminated or cancelled, the DMU initiates the second deactivation stage. The DMU sends deactivation codes 214 corresponding to the second deactivation stage to the respective macros via the communication means. The deactivation codes are then loaded into local shift registers.

Each macro connected to the communication means then processes the deactivation codes 216 to determine what action, if any, each particular macro is to take. Preferably, after sending the deactivation codes to the macros, all macros except the I/O unit are disabled. How each particular macro disables itself depends on the particular macro. For example, disabling can occur by disconnecting power supplies, disabling power-on devices, freezing the system clock, and erasing programs and data stored in a CPU macro, microcontroller macro, and/or memory macro. Data can be erased by activating an erase operation such that all data stored in volatile and/or nonvolatile memory macros is erased. The main objective of the second deactivation stage is to non-destructively disable system macros while preventing the system from being recovered by an intruder, thus preventing critical data or programs from being accessed.

After the second deactivation stage has completed, the DMU determines whether to enter the third deactivation stage 21 8. While waiting to initiate the third deactivation stage, the DMU could transmit a signal through the system I/O interface over a network to a remote service center to seek disposition advice. If the DMU receives a response and the response indicates that the deactivation process should be terminated or cancelled, the DMU can enter into system recovery stage 213 whereby each macro is returned to its normal operating state. Alternatively, if the deactivation indicator suggests that the deactivation stimulus which triggered the indicator has subsided, the DMU can enter into system recovery stage 213. However, if within a predetermined period of time, the deactivation process is not to be terminated or cancelled, the DMU initiates the third deactivation stage. The DMU sends deactivation codes 220 corresponding to the third deactivation stage to the respective macros via the communication means. The deactivation codes are then loaded into local shift registers.

Each macro connected to the communication means then processes the deactivation codes 222 to determine what action, if any, each particular macro is to take. Preferably, after sending the deactivation codes to the macros, various macro operations, except for I/O operations, are disrupted. How each particular macro operation is disrupted depends on the particular macro. For example, disruption can occur by skewing the system clock(s), disabling memory macros, disabling CPUs and/or controller macros, disabling decoupling, disabling timing circuits, disabling power-on sequences, and disabling DC power generators. The system clock can be skewed by introducing noise jitter such as power supply noise or substrate noise by disconnecting decoupling capacitors. A built-in alpha particle generator could be activated to create a tolerable level of soft-error rate so that the memory macros can not reliably retain data. The main objective of the third deactivation stage is to non-destructively disrupt the operation of system macros to prevent the system from being operated by an intruder, thus preventing critical data or programs from being manipulated.

After the third deactivation stage has completed, the DMU determines whether to enter the fourth, and final, deactivation stage 224. While waiting to initiate the fourth deactivation stage, the DMU could transmit a signal through the system I/O interface over a network to a remote service center to seek disposition advice. If the DMU receives a response and the response indicates that the deactivation process should be terminated or cancelled, the DMU can enter into system recovery stage 213 whereby each macro is returned to its normal operating state. Alternatively, if the deactivation indicator suggests that the deactivation stimulus which triggered the indicator has subsided, the DMU can enter into system recovery stage 213. However, if within a predetermined period of time, the deactivation process is not to be terminated or cancelled, the DMU initiates the fourth deactivation stage. The DMU sends deactivation codes 226 corresponding to the fourth deactivation stage to the respective macros via the communication means. The deactivation codes are then loaded into local shift registers.

Each macro connected to the communication means then processes the deactivation codes 228 to determine what action, if any, each particular macro is to take. Preferably, after sending the deactivation codes to the macros, various macros, including the I/O unit, are destroyed, thus rendering the system destroyed 230. How each particular macro is destroyed depends on the particular macro. For example, destruction can occur by shorting power supply(s) to ground or the substrate, or by activating any number of fuse or antifuse elements. By shorting the power supply(s) to ground or the substrate, a high current will flow, thereby damaging the power supply and system battery. Also, the heat generated could burn the system chip and destroy the package and the box to a degree such that any reverse engineering would become nearly impossible. The main objective of the fourth and final deactivation stage is to destroy the system in a manner such that an intruder could not reverse engineer the system.

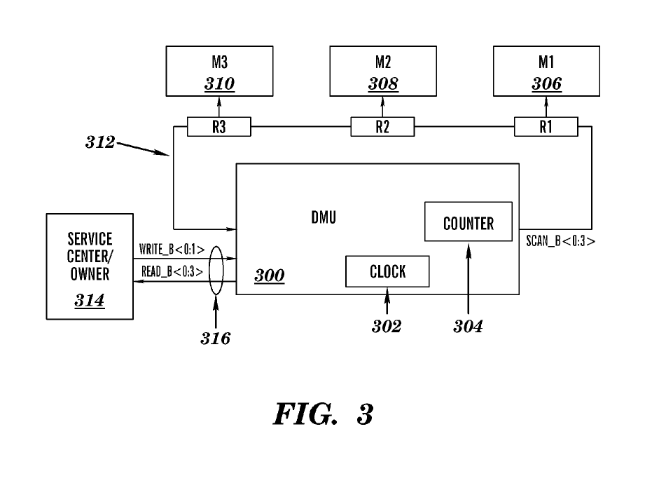

FIG. 3 illustrates an exemplary embodiment of a DMU of the present invention. DMU 300 is a state-machine designed to facilitate an intelligent multistage system deactivation process as previously described. In addition to state-machine circuitry (not shown), DMU 300 also comprises clock circuit 302 and counter 304. Clock circuit 302 enables DMU 300 to continue operation after the system clock has been halted and/or disabled as previously described. Clock circuit 302 can be any suitable circuit adapted to control a counter, such as, for example, a built-in timer circuit or clock generator circuit. Clock circuit 302 causes counter 304 to increment. By incrementing counter 304, the DMU can track how much time has lapsed before entering a particular deactivation stage. Clock circuit 302 and counter 304 can enable DMU 300 to automatically initiate a particular deactivation stage after a certain period of time has lapsed.

DMU 300 initiates a particular deactivation stage by sending deactivation codes (Scan_B<0:3>) from the DMU to first macro 306, second macro 308, and third macro 310 via scan chain 312. For illustrative purpose only, three system macros are illustrated. Any suitable number of system macros can be controlled by the DMU. The deactivation codes are loaded from scan chain 312 into local shift registers R1, R2, and R3. Local shift registers R1, R2, and R3 store the deactivation codes received from scan chain 312 for use by the macro to which they are coupled as previously described. Alternatively, one long shift register could be used where certain outputs of the long shift register would supply the deactivation codes to certain macros. Macros 306, 308, and 310 each receive the deactivation codes from local shift registers R1, R2, and R3, respectively, and processes the codes to determine what deactivation procedure, if any, each particular macro is to execute.

Optionally, DMU 300 can communicate with remote service center 314 by transmitting information (Read_B<0:3>) through the system I/O interface (not shown) over network 316 to seek instruction from the remote service center regarding the deactivation process. Remote service center 314 can transmit information (Write_B<0:1>) to DMU 300 over network 316 where the information indicates whether the deactivation process should be terminated or cancelled, and thus recovered, or continued as previously described. Additionally, remote service center 314 can enable DMU 300 to initiate a particular deactivation stage by transmitting the appropriate instructions to the DMU over network 316. Thus, DMU 300 can initiate a certain deactivation stage automatically as previously described or in response to instructions received from remote service center 314.

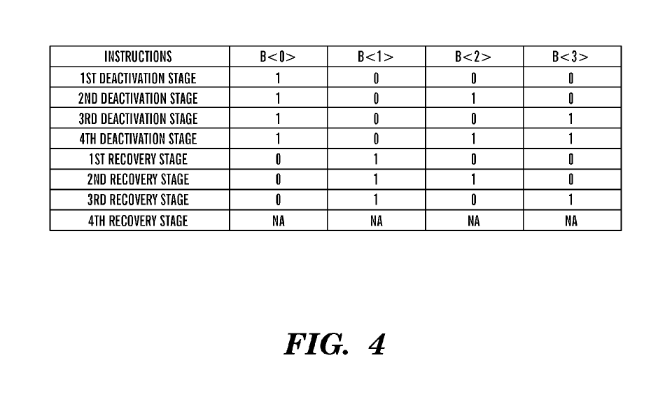

FIG. 4 illustrates exemplary deactivation and recovery codes of the present invention. For example, the deactivation codes (DCs) and recovery codes (RCs) comprise four bits (<B0:B3>). DC bit B<0> can indicate whether the intelligent multistage deactivation scheme is active. If B<0>=1, then the intelligent multistage deactivation scheme is active. Otherwise, the system functions normally. RC bit B<1> can indicate whether the recovery scheme is active. If B<1>=1, then the recovery scheme is active. Otherwise, the recovery scheme is inactive. Bits B<2:3> can indicate the stage of deactivation or recovery, depending on the status of bits <B0:B1> as just described. When DC B<0>=1 and B<2:3>=<0:0>, the first deactivation stage is active. When DC B<0>=1 and B<2:3>=<1:0>, the second deactivation stage is active. When DC B<0>=1 and B<2:3>=<0:1>, the third deactivation stage is active. When DC B<0>=1 and B<2:3>=<1:1>, the fourth deactivation stage is active. When RC B<1>=1 and B<2:3>=<0:0>, the first recovery stage is active. When RC B<1>=1 and B<2:3>=<1:0>, the second recovery stage is active. When RC B<1>=1 and B<2:3>=<0:1>, the third recovery stage is active. When RC B<1>=1 and B<2:3>=<1:1>, no recovery is possible because the system has been, or is being, destroyed as previously described. The deactivation and recovery codes just described and as illustrated in FIG. 4 are for illustrative purposes only. Any number of bits and bit ordering is within the scope of the invention and can depend on several factors such as whether system recovery is available and how many deactivation stages exist.

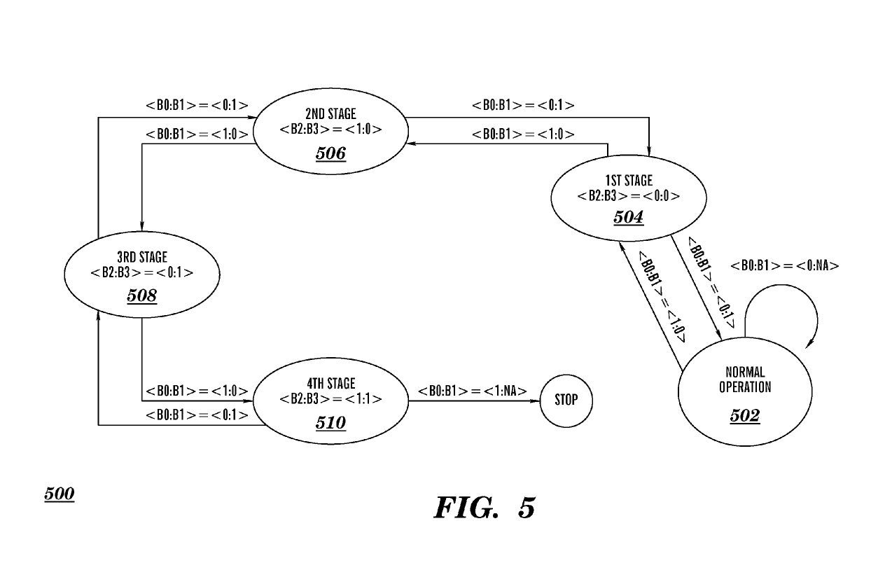

FIG. 5 illustrates an exemplary DMU state machine 500 of the present invention. For illustrative purposes only, the intelligent multistage deactivation process comprises four stages. However, any suitable number of deactivation stages is within the scope of the invention. The system remains in normal operation 502 until a deactivation indictor prompts the DMU to begin analyzing whether the intelligent multistage deactivation process is to be initiated. If the DMU verifies and confirms that the deactivation process is to initiate, then the DMU begins the first deactivation stage 504. If the DMU is unable to verify and confirm that the deactivation process is to initiate, then the system remains in normal operation 502. To initiate first deactivation stage 504, the DMU sends a deactivation code to the macros indicating that the first deactivation stage is to be initiated. In accordance with FIG. 4, DMU can set deactivation bits <B2:B3>=<0:0> to indicate the first deactivation stage. When the system is in first deactivation stage 504, the system can be recovered by the DMU if the DMU issues the appropriate recovery codes to the macros. In accordance with FIG. 4, DMU can set deactivation bit <B0>=<0> and recovery bit <B1>=<1> so that each macro can execute its respective recovery routines.

To enter second deactivation stage 506, the DMU sends a deactivation code to the macros indicating that the second deactivation stage is to be initiated. In accordance with FIG. 4, DMU can set deactivation bits <B2:B3>=<1:0> to indicate the second deactivation stage. When the system is in second deactivation stage 506, the system can be recovered by the DMU if the DMU issues the appropriate recovery code to the macros. In accordance with FIG. 4, DMU can set deactivation bit <B0>=<0> and recovery bit <B1>=<1> so that each macro can execute its respective recovery routines.

To enter third deactivation stage 508, the DMU sends a deactivation code to the macros indicating that the third deactivation stage is to be initiated. In accordance with FIG. 4, DMU can set deactivation bits <B2:B3>=<0:1> to indicate the third deactivation stage. When the system is in the third deactivation stage 508, the system can be recovered by the DMU if the DMU issues the appropriate recovery code to the macros. In accordance with FIG. 4, DMU can set deactivation bit <B0>=<0> and recovery bit <B1 >=<1> so that each macro can execute its respective recovery routines.

To enter fourth and final deactivation stage 510, the DMU sends a deactivation code to the macros indicating that the fourth deactivation stage is to be initiated. In accordance with FIG. 4, DMU can set deactivation bits <B2:B3>=<1:1> to indicate the fourth deactivation stage. Before the fourth deactivation stage begins, the system can be recovered by the DMU if the DMU issues the appropriate recovery code to the macros. In accordance with FIG. 4, DMU can set deactivation bit <B0>=<0> and recovery bit <B1 >=<1> so that each macro can execute its respective recovery routines. However, once stage four deactivation has been initiated, the system can no longer be recovered because the macros have been, or are being, destroyed to prohibit reverse engineering. Thus, the DMU issues no recovery code to the system macros.

An exemplary embodiment of an intelligent multistage deactivation apparatus and method is described next in accordance with system 100 of FIG. 1. When DMU 102 initiates the first deactivation stage, each macro is sent deactivation codes via scan chain 116 as previously described. Each macro stores these codes in local shift registers 120. Each macro processes the deactivation codes to determine what action, if any, each particular macro is to take. When DMU 102 places system 100 in the first deactivation stage, each macro checks its respective local shift register to determine whether that particular macro is to disengage certain features.

For example, eDRAM 104 could erase data stored within its memory array. Data stored within eDRAM 104 can be erased by manipulating the eDRAM refresh circuit. All eDRAM cells must be refreshed within a certain period of time, otherwise, the charge stored in the cell will be lost due to leakage. Refresh circuits typically comprise an address counter and a refresh clock generator. The counter is used to count the wordlines based on the refresh clock rate and decide which wordline must be refreshed. To erase the data stored within an eDRAM during the first deactivation stage, the refresh cycle can be temporarily or permanently avoided, such as by adding a refresh-inhibit control pin, so that the data stored in the eDRAM is lost and cannot be retrieved. The eDRAM refresh circuit can be disabled by a local eDRAM state machine that sequentially activates each stage of eDRAM deactivation. Alternatively, the local eDRAM state machine can write false data into the eDRAM array. By writing false data into the eDRAM array, valid data is replaced by invalid data, thus preventing data tampering.

SRAMs 106A and 106B can also erase data stored within their memory arrays. For example, data stored in the SRAMs can be erased by disconnecting or shorting the SRAM array power supply(s). Recent low-power SRAM designs incorporate a power switch for disconnecting array power supply(s) when the array is in idle. For such low-power SRAMs, a control pin can be added for disconnecting the array power supply(s). Alternatively, a local SRAM state machine that sequentially activates each stage of SRAM deactivation can write false data into the SRAM arrays. By writing false data into the SRAMs, valid data is replaced by invalid data, thus preventing data tampering.

Flash memory 108 can also erase data stored within its memory array. Data stored in Flash memory 108 can be erased by using a block-erase mechanism. Alternatively, a local flash memory state machine that sequentially activates each stage of flash memory deactivation can write false data into the flash memory array. By writing false data into the array, valid data is replaced by invalid data, thus preventing data tampering.

CPU 110 can be disengaged in a number of ways. When in the first deactivation stage, the goal is to halt operation of the CPU. There are numerous ways of halting CPU operation, all of which are within the scope of this invention. For illustrative purposes only, CPU 110 can be halted by initiating an idle routine. Idle routines for CPUs and other controller units are well known in the art, and as such, no further description is necessary. A local CPU state machine that sequentially activates each stage of CPU deactivation can initiate an idle procedure.

Preferably, the I/O interface, comprising receivers 112 and transmitters 114 in FIG. 1, are not disengaged during the first stage of deactivation. Most preferably, the I/O interface functions normally until the system macros are to be destroyed because the I/O interface can be used to communicate with remote locations as previously described. Optionally, the I/O interface could be disengaged. For example, the drivers and receivers of the I/O interface could be put into a tri-state condition (high impedance state). Alternatively, certain circuits within the I/O interface can be disengaged, such as, for example, clock recovery circuits.

When DMU 102 initiates the second deactivation stage, each macro is sent deactivation codes via scan chain 116 as previously described. Each macro processes the deactivation codes to determine what action, if any, each particular macro is to take. When DMU 102 places system 100 in the second deactivation stage, each macro checks its respective local shift register to determine whether that particular macro is to disable certain features. For example, eDRAM 104, SRAMs 106A and 106B, and flash memory 108 can all be powered down. There are numerous techniques for powering down various memory array types, all of which are within the scope of this invention.

CPU 110 can be disabled in a number of ways. For example, all programs stored in the CPU's instruction unit(s) can be erased. The local CPU state machine can initiate an instruction unit flush routine whereby all instructions stored in the instruction units(s) are purged. Alternatively, CPU 110 can be powered down like the various memory macros as previously described. Preferably, the I/O interface is not disabled during the second stage of deactivation for the reasons previously described. Alternatively, the I/O interface could be disabled by powering down the interface.

When DMU 102 initiates the third deactivation stage, each macro is sent deactivation codes via scan chain 116 as previously described. Each macro processes the deactivation codes to determine what action, if any, each particular macro is to take. When DMU 102 places system 100 in the third deactivation stage, each macro checks its respective local shift register to determine whether particular macro functions are to be disrupted.

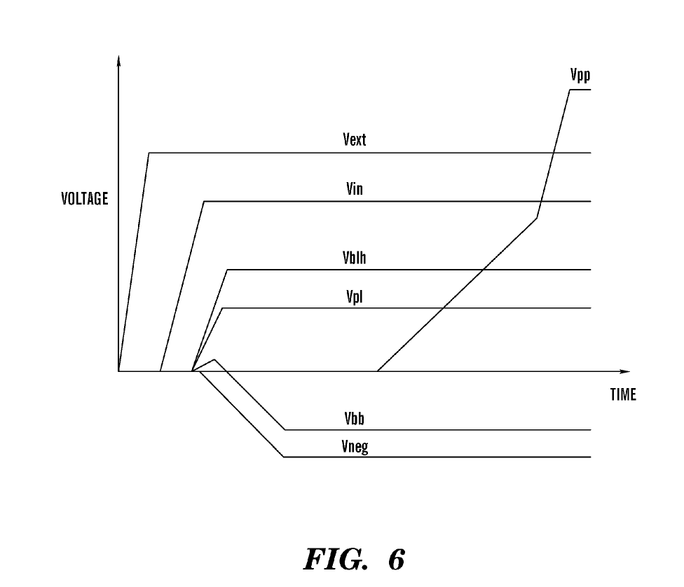

Functionality of eDRAM 104 can be disrupted in a number of ways. For example, the eDRAM power-on sequence can be disabled or corrupted. By disrupting or corrupting the power-on sequence, the eDRAM macro will not function properly. FIG. 6 illustrates an exemplary eDRAM power-on sequence. Typically, multiple internally generated power supplies are required by eDRAMs. For example, an elevated voltage supply (Vpp) must be used to select a wordline. Occasionally, wordline drivers may require a negative voltage (Vneg) to negatively bias all standby wordlines so that charge retention of each cell is preserved. Other times, the substrate may be biased negatively (Vbb) so that memory cells are isolated from the substrate and also to minimize leakage. High density eDRAM arrays may also require a bitline voltage level (Vblh) to bias the bitline. Vblh is generally less than the on-chip power supply voltage and enables high-speed sensing and low power operation. The storage capacitor plate of the memory cells may require a voltage for enhancing charge storage (Vpl). These various internally-generated voltage levels must be turned on in a specific sequence, otherwise, the memory macro will not function properly, or, worse yet, the memory macro can enter into a latch-up state that could cause circuit damage. Referring to FIG. 6, an external voltage (Vext) is ramped up first, followed by the internal supply voltage (Vin). The remaining voltage supplies, except Vpp, are typically derived from Vin. Vblh and Vpl are ramped together, but to different voltage levels. After Vbb and Vneg are ramped negatively and stabilized, Vpp is finally ramped up. Total time required to complete the power-on sequence is typically in the range of 100 to 1000 ns. If the eDRAM power-on sequence circuit is not operational, the eDRAM macro can not function. Also, if the power-on voltage ramping sequence is altered, for example, by ramping Vpp before Vin, the eDRAM macro can not function properly, or worse yet, can be damaged by latch-up effects. A control pin can be provided to temporarily prevent the eDRAM macro from powering up properly.

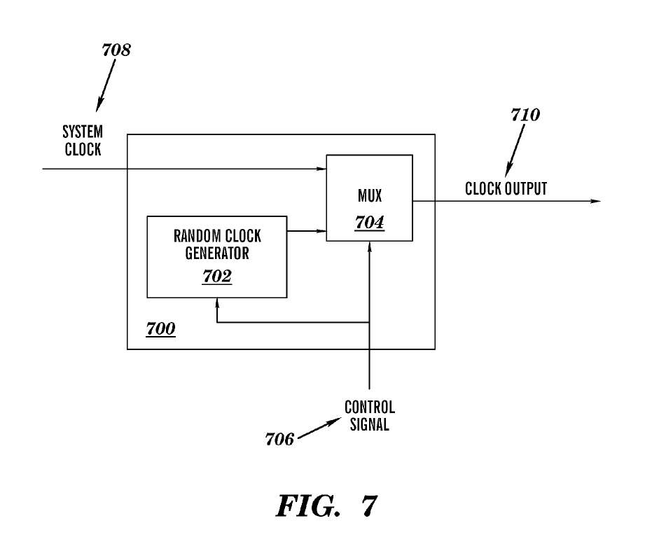

Functionality of SRAMs 106A and 106B can be disrupted in a number of ways. For example, by disabling the SRAM system clock, SRAMs 106A and 106B cannot function properly. As such, the data stored in the SRAM arrays is not valid. Alternatively, an on-chip clock generator can be provided to alter the SRAM system clock frequency. FIG. 7 illustrates an exemplary on-chip clock generator 700. On-chip clock generator 700 comprises a random clock generator circuit 702 and a multiplexer circuit 704. The on-chip clock generator receives control signal 706 from, for example, the local SRAM state-machine. In response to control signal 706, multiplexer 704 selects either system clock 708 or the output of random clock generator 702. When in normal operation, output 710 of the multiplexer is the system clock. When in the third deactivation stage, control signal 706 causes multiplexer 704 to select the output of random clock generator 702 as output 710. Therefore, when operating normally, SRAMs 106A and 106B receive the system clock, and thus function properly. When in the third deactivation stage, the SRAMs are clocked by random clock generator 702, and thus do not function properly. Functionality of flash memory 108 can be disrupted by, for example, disabling the flash memory high voltage generators. Without such high voltage levels, Flash memories cannot be programmed or erased reliably.

Functionality of CPU 110 can be disrupted in a number of ways, for example, by skewing the CPU system clock. By sufficiently skewing the system clock such that duty cycle requirements are not satisfied, CPU 110 can no longer function properly. Alternatively, a clock generator of the type illustrated in FIG. 7 and as previously described could be used to alter the operation of CPU 110. Upon entering the third deactivation stage, the local CPU state machine can activate the clock generator to create random clock frequency. Also, the CPU power-on sequence can be altered by the local CPU state machine such that the CPU can not function properly. The local CPU state machine can also disable on-chip decoupling, which can render CPU 110 unstable or inoperative.

Functionality of the I/O interfaces can be disrupted, if desired. For example, in differential I/O interfaces, the load can be skewed for matching-sensitive differential circuits. By skewing such loads, jitter-induced noise is significantly increased. Alternatively, bias currents can be altered to CML (common mode logic) circuits. Also, current or voltage reference generators can be subjected to noise, thus inducing unreliable operation. Clock cycle distortion can be introduced into clock data recovery circuits, thus disrupting clock and data recovery and causing the received data to be error prone. Optionally, the impedance matching network of an analog I/O interface macro can be tuned such that the data transmitted and received is subjected to attenuation and reflection.

When DMU 102 initiates the fourth and final deactivation stage, each macro is sent deactivation codes via scan chain 116 as previously described. Each macro processes the deactivation codes to determine what action, if any, each particular macro is to take. When DMU 102 places system 100 in the fourth deactivation stage, each macro checks its respective local shift register to determine whether that particular macro is to be destroyed. Each macro can be destroyed by shorting power supply(s) to ground. High amounts of current flow as a result of shorting a power supply to ground and can damage the system power supply and the system battery. Furthermore, the heat generated can destroy the chip, package, and box to a degree where any reverse engineering becomes nearly impossible. Optionally, for those macros having a power-on sequence such as eDRAM 104 and CPU 110, the power-on sequence can be altered as previously described to induce latchup. Latchup can permanently destroy electronic circuitry.

To protect the system from reverse engineering, the system can be designed such that each macro is surrounded by ‘camouflage’ circuits. Camouflage circuits can replace some or all ‘dummy’ circuits. Conventionally, dummy circuits (circuits that have no functional value) have been used to fill unused space to improve process uniformity. The camouflage circuits can be any deactivation circuit of the DMU, such as state machine circuitry, random clock generators, switches, noise generators, or devices to create mismatch. Because these circuits typically are not high performance, and thus, do not have to be of minimal channel length, they are the most optimal choice for filling unused space. Camouflage circuits appear as if they are circuits required for normal functional operation, however, they are not functional during normal operation. They function only during the intelligent multistage system deactivation process. Additionally, no extra space is needed to place camouflage circuits. Thus, by having the deactivation circuits dispersed throughout the system design instead of placed in a central location, reverse engineering becomes nearly impossible.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. An apparatus for deactivating an electronic system, comprising:
means for initiating a multistage deactivation process;
means for initiating a plurality of deactivation stages;
means for sending a deactivation code to a plurality of macros; and
means for recovering from the multistage deactivation process.

2. The apparatus of claim 1, further comprising means for communicating with a remote service center.

3. The apparatus of claim 2, wherein the means for communicating comprises a network.

4. The apparatus of claim 2, wherein the plurality of deactivation stages are initiated in response to information transmitted by the remote service center.

5. The apparatus of claim 1, wherein the means for initiating the multistage deactivation process and the means for recovering from the multistage deactivation process comprise a state machine.

6. The apparatus of claim 5, wherein the state machine initiates the multistage deactivation process in response to a deactivation indicator.

7. The apparatus of claim 6, wherein the deactivation indicator is selected from the group consisting of: indication of system tampering, security alarm, non-standard operating mode, license expiration, password expiration, and ID expiration.

8. The apparatus of claim 1, wherein the means for sending the deactivation code comprises a scan chain.

9. The apparatus of claim 1, wherein the means for initiating the plurality of deactivation stages comprises a clock circuit and a counter.

10. An electronic system, comprising:
a plurality of macros; and
a deactivation management unit (DMU) coupled to each of the plurality of macros and adapted to facilitate a multistage deactivation process, wherein the multistage deactivation process is initiated in response to a deactivation indicator and comprises a plurality of deactivation stages, each of the deactivation stages being recoverable except for a final deactivation stage.

11. The electronic system of claim 10, wherein the system is a System-On-Chip.

12. The electronic system of claim 10, further comprising a network, wherein a remote service center communicates with the DMU over the network.

13. The electronic system of claim 10, wherein the DMU is coupled to the plurality of macros by a communication means.

14. The electronic system of claim 13, wherein the communication means comprises a scan chain.

15. The electronic system of claim 13, wherein the DMU sends a deactivation code to the plurality of macros over the communication means.

16. The electronic system of claim 10, wherein circuits comprising the DMU are dispersed throughout the electronic system.

17. A method of deactivating an electronic system, comprising the steps of:
initiating a multistage deactivation process;
initiating a plurality of deactivation stages;
executing the plurality of deactivation stages, wherein each deactivation stage is executed in response to a deactivation code; and
deactivating the plurality of macros, wherein each macro is deactivated in accordance with one of the plurality of deactivation stages.

18. The method of claim 17, further comprising the step of recovering the electronic system in response to a recovery code.

19. The method of claim 18 , wherein the recovery code is transmitted by a remote service center.

20. The method of claim 17, wherein the plurality of deactivation stages comprises:
disengaging at least one of the plurality of macros;
disabling at least one of the plurality of macros;
disrupting operation of at least one of the plurality of macros; and
destroying at least one of the plurality of macros.

21. The method of claim 20, wherein at least one of the plurality of macros is disengaged in accordance with a mechanism selected from the group consisting of: erasing data stored in a memory macro, halting operation of a controller macro, and tri-stating drivers and receivers of an I/O interface macro.

22. The method of claim 20, wherein at least one of the plurality of macros is disabled in accordance with a mechanism selected from the group consisting of: powering down a memory macro, erasing programs and data stored in a controller macro, and powering down an I/O interface macro.

23. The method of claim 20, wherein at least one of the plurality of macro operations is disrupted in accordance with a mechanism selected from the group consisting of: disabling a power-on sequence of a DRAM macro, disabling a timing circuit of a SRAM macro, disabling a voltage generator circuit of a flash memory macro, disabling decoupling capacitance of a controller unit, disabling a power-on sequence of the controller unit, skewing a clock signal of the controller unit, skewing a differential circuit load of an I/O interface macro, altering bias currents of the I/O interface macro, subjecting current or voltage reference generators of the I/O interface to noise, distorting a clock cycle of the I/O interface macro, and tuning an impedance matching network of the I/O interface macro to induce attenuation and reflection.

24. The method of claim 20, wherein at least one of the plurality of macros is destroyed by a mechanism selected from the group consisting of:
shorting a power supply to ground, altering a power-on sequence of a DRAM memory macro, and altering a power-on sequence of a controller macro.
